(19) United States
(12) Patent Application Publication
(10) Pub. No.: US 2021/0107121 A1
(43) Pub. Date: Apr. 15, 2021

(54) TOOL AND METHOD FOR ACTUATING A TOOL

(71) Applicant: STAHLWILLE EDUARD WILLE GMBH & CO. KG, WUPPERTAL (DE)

(72) Inventor: WINFRIED CZILWA, WUPPERTAL (DE)

(73) Assignee: STAHLWILLE EDUARD WILLE GMBH & CO. KG, WUPPERTAL (DE)

(21) Appl. No.: 17/055,355

(22) PCT Filed: May 13, 2019
(86) PCT No.: PCT/EP2019/062212

§ 371 Date: Nov. 13, 2020

(30) Foreign Application Priority Data
May 15, 2018 (DE) 10 2018 111 652.7

(51) Int. Cl. B25B 23/14; B25B 21/00

(52) U.S. Cl. CPC B25B 23/14; B25F 5/00; B25B 21/00

(57) ABSTRACT

The invention relates to a torque tool, a torque testing device or a rotational angle testing device, with a user identification unit for identifying the user of the tool. The system further includes a user data unit in which user-specific data for handling the tool are collected, a work data unit in which work data for applications of the tool are collected, a learning unit connected to the user data unit, and the work data unit, in which data are recorded during an operation of the tool by the user and are compared with the data collected in the user data unit and the work data unit and are adapted in the event of a deviation. An adaptation unit is connected to the user data unit and the work data unit, and the operation of the tool is adaptable and controllable, depending on the user-specific data and the work data.

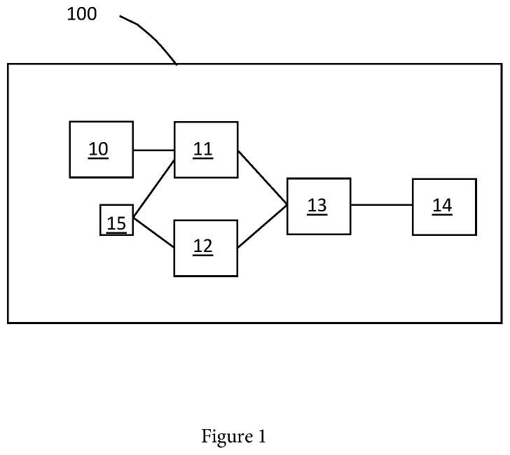

### CROSS REFERENCE TO RELATED APPLICATIONS

This application claims priority to International Application No. PCT/EP2019/062212, filed on May 13, 2019, which itself claims priority to German Patent Application No. 102018111652.7, filed on May 15, 2018, each of which are hereby incorporated by reference in their entireties.

### DESCRIPTION

The present invention relates to a tool, in particular a torque tool, a torque testing device or a rotation angle testing device. Further, the invention relates to a method for operating a corresponding tool.

### PRIOR ART

In the case of hand-held tools, in order to be able to achieve optimal results, the correct operation of the tool depends to a large extent on the type of operation of the tool by the user. A hand-held tool can be, for example, a hand-held screwing tool, such as a torque tool, with which a defined tightening torque can be exerted on a connecting element, such as a screw or nut, in order to guarantee the necessary clamping force between the components to be connected also during the application of the maximum operating forces. Incorrect operation of the tool by the user can, for example, result in over-tearing. However, it is also possible that the torque applied is too low, so that no sufficient connection can be established between the components to be connected. The work result achieved with the tool can therefore vary greatly, depending on the user of the tool.

### PRESENTATION OF THE INVENTION: TASK, SOLUTION, ADVANTAGES

It is therefore the object of the present invention to provide a tool as well as a method for operating a tool for which the handling and the work result achieved can be improved.

This object is achieved with the features of the independent claims. Advantageous embodiments and developments of the invention are specified in the dependent claims.

The tool according to the invention is characterized in that it has a user identification unit for identifying the user of the tool, a user data unit in which user-specific data for handling the tool are collected, a work data unit in which work data for applications of the tool are collected, a learning unit connected to the user data unit and the work data unit in which data are detected during an operation of the tool by the user and are compared with the data collected in the user data unit and the work data unit and are adapted, and an adaptation unit connected to the user data unit and the work data unit by means of which, depending on the user-specific data and the work data, the operation of the tool is adaptable and controllable.

Furthermore, the method for operating a tool is characterized in that a user of the tool is identified in a user identification unit, user-specific data for handling the tool are collected in a user data unit, work data for applications of the tool are collected in a work data unit, during an operation of the tool by the user data are detected in a learning unit connected to the user data unit and the work data unit and are compared with the data collected in the user data unit and the work data unit and are adapted, and the operation of the tool is adapted and controlled in an adaptation unit connected to the user data unit and the work data unit, depending on the user-specific data and the work data.

In this way, an intelligent tool can be created which can be adapted to a user, so that the handling of the tool for the user and also the work result achieved with the tool can be improved. The tool can identify the user of the tool, so that the type of operation of the tool can be set specifically for this user, so that each user can be assigned an individual way of operating or handling the tool. The application is also taken into account, i.e. which application is currently to be carried out with the tool, so that the type of use of the tool can also be taken into account when controlling the tool.

At first, the current user of the tool is identified, so that the tool knows from the start which user is currently operating the tool. If user-specific data on this user have already been collected in the user data unit, then these data can be compared so that the tool already recognizes how the type of operation of the tool by this user has taken place during previous operations. If this is a new user who has not used the tool before, this user can be entered as a new user into the user data unit, so that the current and future user-specific data on this user can be collected there. If the tool is operated, both data from the user data unit and from the work data unit are used as a basis in order to adapt the operation of the tool to the current user and also to the current application. While the tool is being operated, new data on the type of operation by the user are recorded by a learning unit and are compared with the data of the user data unit and the work data unit, wherein, in the event of deviations in the data or new data, these data are collected in the user data unit and/or the work data unit and are adapted or updated. Thus, a learning system can be created, whereby a continuous optimization of the operation of the tool can be achieved. Furthermore, an adaptation unit is provided which is in connection with at least the user data unit and the work data unit, so that the operation of the tool can be adapted and controlled, depending on the data of the user data unit and the work data unit.

The user-specific data can comprise, for example, data on personal identification and/or data on the type of force exerted by the user and/or data on a torque that can be achieved by the user and/or data on the type and extent of over-tearing by a user. The user-specific data thus preferably comprise data on the type of operation or handling of the tool by the respective user. Individual data on the person of the user himself are also preferably recorded in the form of a personal identifier as user-specific data in the user data unit, so that each user can be assigned his own data or his own user-specific data. Each user operates a tool differently. For example, each user applies a force differently to the tool. The torque that can be achieved can also vary for each user. Furthermore, the risk of over-tearing varies depending on the respective user. All of these data can be collected as user-specific data in the user data unit. Further user-specific data are also conceivable.

The work data can comprise, for example, data on the type of screw joints and/or data on a screw-in angle and/or data on a material of the screw-in means and/or data on a material into which the screwing occurs. Further work data are also conceivable. A screw joint can be hard or soft, for example. In the case of a hard screw joint the screw head hits a hard surface, causing the torque to increase suddenly. In the case of a soft screw joint, however, the torque increases more slowly and therefore more softly. Furthermore, the screw-in angle can be different depending on the application, which means that the type of operation of the tool is also different and must be adapted accordingly. Also, the material of the screw-in means, such as a screw, but also the material into which the screwing occurs can influence the operation of the tool.

The data of the user data unit and the work data unit can be stored in the respective data units themselves, so that the user data unit and the work data unit can each be assigned their own database. However, it is also possible that a central database is provided to which the user data unit and the work data unit are assigned, so that the user data unit and the work data unit can archive and store their data in a central database, so that they do not need to have a database themselves and thus not an own storage.

This central database can be arranged within the tool and can thus integrated in the tool. However, it is also possible that the central database is positioned outside the tool. The user data unit and the work data unit can be connected to the central database via a radio connection or a cable connection in order to transmit the data to the central database.

The user who is currently operating the tool can be identified in various ways in the user identification unit. For example, by entering an identifier by the user, wherein a specific identifier can be assigned to each user. The identifier can be a number code, for example. Also, the insertion or detection of an identification card or an identification stick is possible. Furthermore, the identification can also occur via biometric data of the user, for example a fingerprint. It is also possible to read in an optical code, such as a QR code, which is assigned to a user. The user is preferably identified at the beginning of the operation of the tool.

If, due to the user-specific data and the work data, an adaptation of the tool or an adaptation of the working method of the tool is necessary when the tool is operated, this adaptation can take place automatically without the user noticing. However, it is also possible for the adaptation unit to output a warning message to the user when the operation of the tool is adapted, so that he perceives the adaptation and, if necessary, can also recognize which form of adaptation is taking place on the tool. The warning message can be given, for example, by an optical and/or acoustic signal.

It is also possible that the user data unit and/or the work data unit and/or the central database can be connected to a company software system, such as a PPS/ERP system, by means of cable or radio, so that a comparison of data between this company software system and the user data unit and/or the work data unit and/or central database can take place. The comparison can be used, for example, to determine the location at which the tool is currently located. Further, an input or transfer of data from a work plan of the company software system into the central database and/or the work data unit and/or the user data unit is possible. In addition, data, such as an actual tightening torque, the number of screw connections carried out, times, user ID or the like, can be transmitted from the tool or from the work data unit and/or the user data unit and/or the central database to the company software system and can be evaluated and/or managed there.

### BRIEF DESCRIPTION OF THE DRAWING

Further measures improving the invention are shown in more detail below together with the description of a preferred embodiment of the invention with reference to the single FIGURE.

The single FIGURE schematically shows a tool according to the invention.

### PREFERRED EMBODIMENTS OF THE INVENTION

In the single FIGURE, a tool 100 is shown in a highly simplified schematic. The tool 100, in particular a hand-held tool, can be, for example, a torque tool, a torque testing device or a rotational angle testing device. Other types of tools 100 are also conceivable.

The tool 100 has a user identification unit 10. The user who is currently operating the tool 100 is identified via the user identification unit 10. Personal data relating to various users can be stored in the user identification unit 10, so that the user who identifies himself on the tool 100 can be identified and assigned. To identify the user, he can, for example, manually enter an identifier in the form of a number code or have it read in using a card or stick. Furthermore, the identification can also occur using biometric data of the user, in that the user identifies himself with his fingerprint on the user identification unit 10. Other options are an optical code or an RFID or NFC system to identify the user. Furthermore, it is also possible for the user to log into a central system arranged remotely from the tool 100, wherein this central system then preferably is able to forward the read-in data to the user identification unit 10 in the tool 100 via radio.

The user identification unit 10 is connected to a user data unit 11 by radio or cable. In this user data unit 11, user-specific data for handling the tool 100 are collected. For each user, user-specific data can thus be assigned in the user data unit 11, which can be called up during or for the operation of the tool 100. The tool 100 can thus recognize how the user has handled the tool 100 in his previous uses or how he was able to deal with it. The user-specific data preferably comprise a person identifier which is compared with the data from the user identification unit so that a user can be clearly identified and further user-specific data can be assigned to him. Furthermore, the user-specific data can be the torque that can be achieved, the type of force application and/or the type and extent of over-tearing by the user.

In addition to the user-specific data, the tool also knows work data for different applications, which are collected in a work data unit 12. Work data can be, for example, the type of screw joints, screw-in angle, material of the screw-in means and/or material into which screwing occurs.

In order to be able to keep the user-specific data of the user data unit 11 and the work data of the work data unit 12 up to date and to be able to adapt them again and again, a learning unit 13 is provided, which is connected to the user data unit 11 and the work data unit 12 via cable or radio. In the learning unit 13, data are recorded during an operation of the tool 100 by the user and compared with the data collected in the user data unit 11 and the work data unit 12 and adjusted in the event of a deviation in the user data unit 11 and in the work data unit 12. Due to the learning unit 13, a learning of the tool 100 can occur, since it can be continuously adapted and optimized to the characteristics of the respective user and the characteristics of the respective application. The learning unit 13 can comprise, for example, one or more sensors, via which the type of handling by the user and also the current application can be recognized and recorded.

To adjust the tool 100 to the respective user and the respective application, an adaptation unit 14 is also provided, by means of which the operation of the tool 100 can be adapted and controlled depending on the user-specific data of the user data unit 11 and the work data of the work data unit 12. The adaptation unit 14 can detect and compensate for deviations in the planned work by means of the tool 100. The adaptation unit 14 can also output a warning message to the user, so that the user receives feedback and recognizes that there is a deviation and that an adaptation is taking place. The warning can be given by an optical or an acoustic signal.

Furthermore, on the basis of the specific handling of the tool 100 by the user, it can also be recognized whether this is the user logged on to the user identification unit 10, and if a user logged on incorrectly, a corresponding feedback can be output on the adaptation unit 14 via a warning message.

The tool 100 thus has an intelligent control system, so that the tool 100 is able to recognize the user-specific data and the work data and to control a use or handling of the tool by the user via the adaptation unit 14 in such a way that an optimal work result can be achieved for the respective user and the respective application. This can be achieved, for example, by the user tightening an exemplary screw joint several times, in which the tool 100 records the data in the learning unit 13 and adapts the data in the user data unit 11 and the work data unit 12 accordingly, so that an adaptation of the operation and the manner of operating of the tool 100 can occur via the adaptation unit 14.

In the embodiment shown here, the data of the user data unit 11 and the work data unit 12 are stored in a central database 15 which is arranged in the tool 100. The user data unit 11 and the work data unit 12 are each connected to the central database 15 by radio or cable.

The embodiment of the invention is not limited to the preferred embodiment specified above. Rather, a number of variants are conceivable which make use of the solution shown even in the case of fundamentally different designs. All of the features and/or advantages that emerge from the claims, the description or the drawings, including structural details, spatial arrangements and method steps, can be essential to the invention both individually and in a wide variety of combinations.

1. A tool, in particular a torque tool, a torque testing device or a rotation angle testing device, with
a user identification unit for identifying the user of the tool,
a user data unit in which user-specific data for handling the tool are collected,
a work data unit, in which work data for applications of the tool are collected,
a learning unit connected to the user data unit and the work data unit, in which data are recorded during an operation of the tool by the user and compared with the data collected in the user data unit and the work data unit and adapted in the event of a deviation, and
an adaptation unit connected to the user data unit and the work data unit, by means of which the operation of the tool is adaptable and controllable, depending on the user-specific data and the work data.

2. The tool according to claim 1, characterized in that the user-specific data
comprise data on the personal identification and/or data on the type of force applied by the user and/or data on a torque that can be achieved by the user and/or data on the type and extent of an over-tearing by a user.

3. The tool according to claim 1, characterized in that the working data
comprise data on the type of screw joint and/or data on a screw-in angle and/or data on a material of the screw-in means and/or data on a material into which the screwing takes place.

4. The tool according to claim 1, characterized in that the user
data unit and the work data unit are assigned to a central database.

5. The tool according to claim 4, characterized in that the central database
is arranged in the tool.

6. A method for operating a tool, in particular a torque tool, a torque testing
device or a rotational angle testing device, in which a user of the tool is identified in a user identification unit, user-specific data for handling the tool are collected in a user data unit, work data for applications of the tool are collected in a work data unit, data are recorded in a learning unit connected to the user data unit and the work data unit during an operation of the tool by the user and are compared with the data collected in the user data unit and the work data unit and are adapted in the event of a deviation, and the operation of the tool is adapted and controlled in an adaptation unit connected to the user data unit and the work data unit, depending on the user-specific data and the work data.

7. The method according to claim 6, characterized in that a user is identified in the
user identification unit by entering an identifier and/or recording the biometric data and/or reading in an optical code.

8. The method according to claim 6, characterized in that the adaptation unit
outputs a warning message to the user when the operation of the tool is adapted.
